(19) United States
(12) Patent Application Publication
(10) Pub. No.: US 2007/0002906 A1
(43) Pub. Date: Jan. 4, 2007

(54) Up-conversion optical fiber laser with external cavity structure

(75) Inventors: Kiyoyuki Kawai, Suwon (KR); Jae Chul Yong, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/476,144

(22) Filed: Jun. 28, 2006

(30) Foreign Application Priority Data
Jun. 30, 2005 (KR) 10-2005-0057908

(51) Int. Cl. H01S 3/30; H01S 3/08

(52) U.S. Cl. 372/6; 372/98; 372/99; 372/106

(57) ABSTRACT

The invention provides an up-conversion optical fiber laser apparatus with an external resonator structure. In the invention, a laser element outputs light of a first wavelength to excite an up-conversion optical fiber doped with rare earth ions used for converting the first wavelength light into a second wavelength light. An output mirror is disposed at an output end of the optical fiber, and cooperates with a high reflective layer of the laser element to operate as a resonator for the first wavelength light. An input mirror is disposed at an input end of the optical fiber and cooperates with the output mirror to operate as a resonator for the second wavelength. A polarization mode controller converts light incident from the optical fiber into light of eigen-polarization wave for the laser element and outputs the converted light to the laser element. Further, a beam transformer converts light incident from the polarization mode controller into a shape required by the optical fiber and outputs the transformed light to the optical fiber, and vice versa.

### CLAIM OF PRIORITY

This application claims the benefit of Korean Patent Application No. 2005-57908 filed on Jun. 30, 2005, in the Korean Intellectual Property Office, the disclosure of which is incorporated herein by reference.

### BACKGROUND OF THE INVENTION

1. Field of the Invention

The present invention relates to an up-conversion optical fiber laser apparatus. More particularly, the present invention relates to an up-conversion optical fiber improved in conversion efficiency by introducing a stable external cavity or resonator structure which ensures excitation light to be distributed at a uniform intensity.

2. Description of the Related Art

In general, an up-conversion optical fiber laser apparatus generates a beam of a shorter wavelength than pump wavelength with higher conversion efficiency by optically pumping optical fiber having a core doped with a rare earth ion such as Pr, Yb, Tm, Ho or Er via an excitation laser device having a given wavelength. Such an up-conversion optical fiber laser apparatus employs a relatively low-priced infrared laser diode or device as the excitation laser device, thereby advantageously obtaining red or green laser beam.

FIGS. 1(a) and (b) are examples of a conventional up-conversion optical fiber laser apparatus which generates light of a wavelength of 635 nm.

The up-conversion optical fiber laser apparatus 10 as shown in FIG. 1(a) includes an excitation laser device 11 for outputting an excitation laser beam and an optical fiber 19 having a core doped with rare earth ions. The rare earth ions doped in the core of the optical fiber 19 are exemplified by Pr ion and Yb ion. The excitation laser device 11 generates light of a wavelength of 835 nm.

Typically, the excitation laser device 11 has a resonator structure C1 in which a low reflective layer M2 (about 10% at 835 nm) is disposed on a light exiting area and a high reflective HR layer M1 is coated on an opposed area. The excitation light exiting from the laser device 11 enters the optical fiber 19 through a light focusing means 12 such as a collimator or a lens. An input mirror DM1 is disposed at an input end of the optical fiber 19 and an output mirror DM2 is disposed at an output end of the optical fiber 19. The input mirror DM1 exhibits anti-reflectivity or non-reflectivity at an excitation wavelength of 835 nm and high-reflectivity at a wavelength of 635 nm. Meanwhile, the output mirror DM2 demonstrates high reflectivity at a wavelength of 835 nm and low-reflectivity of 10% to 30% at a wavelength of 635 nm. The input and output mirrors DM1 and DM2 cooperatively enable the optical fiber 19 to operate as a resonator C2 for light of a wavelength of 635 nm.

FIG. 1(b) illustrates the intensity of a pumping or excitation light in the optical fiber 19 as shown in FIG. 1(a). As indicated with an arrow a, the excitation light incident from the input end of the up-conversion optical fiber 19 is absorbed into rare earth ions doped in the core of the optical fiber, thus diminishing along an axis direction. However, in case of insufficient absorption by the optical fiber, the excitation light does not diminish to 0 at the output end of the up-conversion optical fiber 19. Such remaining light is absorbed into rare earth ions and return to the input end as indicated with b. Bold line c denotes sum of a and b, indicating the intensity of a total excitation light. Reflection through the output mirror DM2 allows increased light intensity as indicated with b. Efficiency of conversion from infrared to visible ray depends on the intensity of the excitation light. Therefore, as described above, increment in the intensity of a total excitation light enhances conversion efficiency of the laser apparatus 10.

However, light returning to the laser device 11 causes fluctuation in an output of the laser device 11, potentially damaging the laser device 11 in the worst case. FIG. 2 illustrates an up-conversion optical fiber laser apparatus 20 with an external resonator structure, which has been proposed in a method to solve the problem and enhance conversion efficiency of the fiber laser. The external resonator structure enables light returning to the laser device 11 to serve as an active oscillation component.

In an up-conversion optical fiber laser apparatus 20 shown in FIG. 2, in a similar manner to FIG. 1, an input mirror DM1 and an output mirror DM2 are configured to operate as a resonator Cf so that an optical fiber 29 generates light of a wavelength of 635 nm by up-conversion. But a light exiting area of the laser device 21 is coated to have almost zero reflectivity (at 835 nm), thereby extending the resonator structure Ce of the laser device 21 from a high reflective (HR) layer M1 facing the laser device 21 to an output mirror DM2 of the optical fiber 29. Such external resonator structure Ce of the laser device 21 uses a beam returning from the high reflective output mirror DM2 as an oscillation component, thus allowing an excitation light to be distributed at a relatively uniform intensity along the optical fiber 29. Also, due to the up-conversion optical fiber 29 positioned inside the external resonator structure Ce, the intensity of the excitation light in the optical fiber 29 can be considerably increased.

However, this effect is only theoretically plausible but practically not. This results from very low efficiency of optical coupling between the optical fiber 29 and the laser device 21. In general, the optical fiber has birefringence whose magnitude and orientation are subject to change in accordance with circumstances. This renders light returning from the optical fiber hardly combinable with the laser device stably. Also, typically, the optical fiber has a multiple mode while the laser device has a single mode along a fast axis, inevitably leading to low optical coupling efficiency.

### SUMMARY OF THE INVENTION

The present invention has been made to solve the foregoing problems of the prior art and it is therefore an object of the present invention to provide an up-conversion optical fiber laser apparatus with an external cavity or resonator structure improved in conversion efficiency by adjusting the polarization state and shape of a beam reversibly and thus enhancing efficiency of optical coupling between a laser device and optical fiber.

According to an aspect of the invention for realizing the object, there is provided a laser element for outputting a first wavelength light, the laser element including a non-reflectivity layer formed on a light exiting area and a high reflective layer formed on an opposite area; an up-conversion optical fiber having a core doped with a rare earth substance to convert the first wavelength light into a second wavelength light; an output mirror disposed at an output end of the up-conversion optical fiber, the output mirror cooperating with the high reflective layer of the laser element to enable a predetermined portion of the laser apparatus from the laser element to the optical fiber to operate as a resonator for the first wavelength light; an input mirror disposed at an input end of the up-conversion optical fiber, the input mirror cooperating with the output mirror to enable the optical fiber to operate as a resonator for the second wavelength light; a polarization mode controller disposed between the laser element and the up-conversion optical fiber, for converting light incident from the optical fiber into light of eigen-polarization wave for the laser element and outputting the converted light to the laser element; and a beam transformer disposed between the polarization mode controller and the up-conversion optical fiber, for converting light incident from the polarization mode controller into a shape required by the optical fiber for efficient coupling, and inversely, light incident from the optical fiber into a shape required by the laser element and outputting the transformed light to the polarization mode controller.

Preferably, the polarization mode controller comprises: a phase retarder for converting incident light into an orthogonal polarization wave; a first polarization beam divider for reflecting only one eigen-polarization wave component for the laser element among the light returning to the laser element so that the reflected wave component directly exits to the laser element; and a second polarization beam divider for allowing passage of only the other polarization wave component, orthogonal with respect to the eigen-polarization wave component so that the allowed wave component exits to the laser element as the eigen-polarization wave component through the phase retarder.

Alternatively, the first polarization beam divider may be substituted by a mirror having a high reflectivity (preferably almost 100%). That is, substitution of the first polarization beam divider by a mirror having a reflectivity of 100% simplifies the polarization mode controller and still allows passage of the eigen-polarization wave component reflected from the second polarization beam divider, i.e., the eigen-polarization wave component to exit to the laser element.

According to one embodiment of the invention, preferably, the first polarization beam divider is structured such that reflected wave component of the incident light travels to the second polarization beam divider, and the second polarization beam divider is structured such that reflected wave component of the incident light travels to the first polarization beam divider. Also, the polarization mode controller is structured to divide light incident from the laser element such that a portion of the light enters the first polarization beam divider and another portion of the light enters the second polarization beam divider. Preferably, the polarization mode controller divides light incident equally from the laser element along a slow axis. ( [symbol] )

Preferably, the beam transformer divides light incident from the polarization mode controller, rotates the divided light at a predetermined angle, rearranges the light, and output to the optical fiber, and inversely, divides light incident from the optical fiber, rotates the divided light at a predetermined angle, and rearrange the light approximately into a shape of the incident light from the polarization mode controller. At this time, preferably, the light is divided by the beam transformer along a slow axis.

Preferably, the input mirror disposed at the input end of the optical fiber has non-reflectivity for the first wavelength light, and high reflectivity of 95% or more for the second wavelength light. Preferably, the output mirror disposed at the output end of the optical fiber has high reflectivity of 95% or more for the first wavelength light and low reflectivity of 10% to 30% for the second wavelength light.

According to another embodiment of the invention, an up-conversion optical fiber laser apparatus comprises: first and second laser elements for outputting a first wavelength light, each of the first and second laser elements including a non-reflective layer formed on a light exiting area and a high reflective layer formed on an opposite area; an up-conversion optical fiber having a core doped with a rare earth substance to convert the first wavelength light into a second wavelength light; first and second mirrors disposed at both ends of the up-conversion optical fiber, the first and second mirrors having non-reflectivity for the first wavelength light so that high reflective layers of the first and second laser elements operate as a resonator for the first wavelength light, and having high-reflectivity and low-reflectivity for the second wavelength light, respectively, so that the optical fiber operates as a resonator for the second wavelength light; first and second polarization mode controllers disposed between the first and second laser element and both ends of the up-conversion optical fiber, respectively, wherein the first polarization mode controller is adapted to convert light incident from the optical fiber into light of eigen-polarization wave for the first laser element and outputs the converted light to the first laser element, and the second polarization mode controller is adapted to convert light incident from the optical fiber into light of eigen-polarization wave for the second laser element and outputs the converted light to the second laser element; first and second beam converters disposed between the first and second polarization mode controllers and the both ends of the up-conversion optical fiber, respectively, wherein the first beam transformer is adapted to convert light incident from the first polarization mode controller into a shape required by the optical fiber, and inversely, convert light incident from the optical fiber into a shape required by the first laser element and outputs the transformed light to the first polarization mode controller, and the second beam converter is adapted to transformer light incident from the second polarization mode controller into a shape required by the optical fiber, and inversely, convert light incident from the optical fiber into a shape required by the second laser element and outputs the transformed light to the second polarization mode controller; and a final output mirror having non-reflectivity for the first wavelength light and high-reflectivity for the second wavelength light, by which the second wavelength light outputted from the second mirror exits outside a resonator structure.

According to further another embodiment of the invention, an up-conversion optical laser apparatus comprising: a laser element for outputting a first wavelength light, the laser element including a non-reflective layer formed on a light exiting area and a high reflective layer formed on an opposite area; an up-conversion optical fiber having a core doped with a rare earth substance to convert the first wavelength light into a second wavelength light; first and second mirrors disposed at both ends of the up-conversion optical fiber, the first and second mirrors having non-reflectivity for the first wavelength light so that high reflective layer of the laser element operate as a resonator for the first wavelength light, and having high-reflectivity and low-reflectivity for the second wavelength light, respectively, so that the optical fiber operates as a resonator for the second wavelength light; a polarization mode controller disposed between the laser element and the up-conversion optical fiber, for converting light incident from the optical fiber into light of eigen-polarization wave for the laser element and outputting the converted light to the laser element; a beam transformer disposed between the polarization mode controller and the up-conversion optical fiber, for converting light incident from the polarization mode controller into a shape required by the optical fiber for efficient coupling, and inversely, light incident from the optical fiber into a shape required by the laser element and outputting the transformed light to the polarization mode controller; two light focusing means disposed in parallel such that the both ends of the up-conversion optical fiber are optically connected to the beam transformer; and a final output mirror having non-reflectivity for the first wavelength light, and high reflectivity for the second wavelength light, by which the second wavelength light outputted from the second mirror exits outside a resonator structure.

In this specification, “high reflectivity” or “high reflection” denotes having a reflectivity of 90% or more, preferably 95% or more, and more preferably almost 100% for a given wavelength. Meanwhile, “low reflectivity” or “low reflection” denotes having a reflectivity, preferably, 4% to 90%, more preferably 10 to 30%, lower than the high reflectivity.

### BRIEF DESCRIPTION OF THE DRAWINGS

The above and other objects, features and other advantages of the present invention will be more clearly understood from the following detailed description taken in conjunction with the accompanying drawings, in which:

FIG. 1(a) illustrates a conventional up-conversion optical fiber laser apparatus, and FIG. 1(b) illustrates the intensity of an excitation light distributed in the optical fiber;

FIG. 2 illustrates a conventional up-conversion optical fiber laser apparatus with an external resonator structure;

FIG. 3 illustrates an up-conversion optical fiber laser apparatus with an external resonator structure according to one embodiment of the invention;

FIGS. 4(a) to (d) are schematic views for explaining a process of adjusting beam shapes to improve optical coupling efficiency according to one embodiment of the invention;

FIG. 5 illustrates an up-conversion optical fiber laser apparatus with external resonator structure according to another embodiment of the invention;

FIG. 6 is a graph illustrating the intensity of an excitation light distributed in the up-conversion optical fiber laser apparatus of FIG. 5; and

FIG. 7 is an up-conversion optical fiber laser apparatus with external resonator structure according to further another embodiment of the invention.

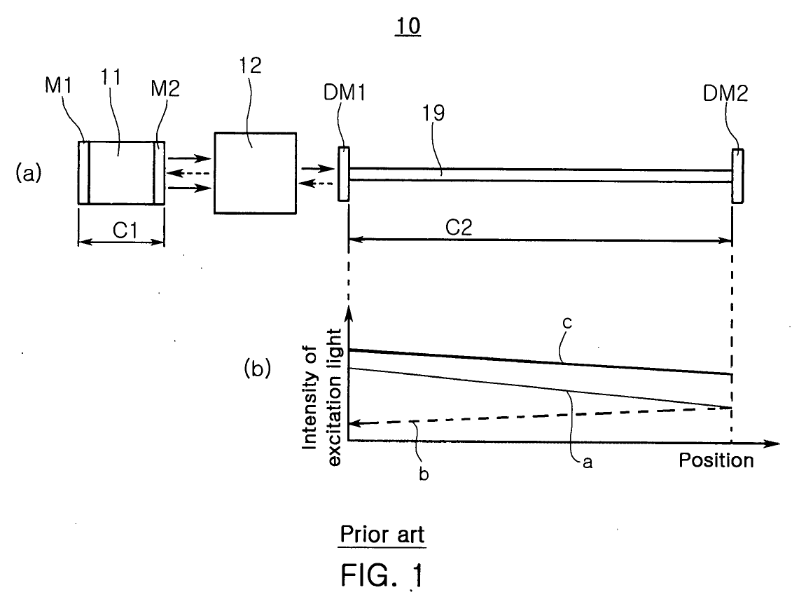

### DETAILED DESCRIPTION OF THE PREFERRED EMBODIMENT

Preferred embodiments of the present invention will now be described in detail with reference to the accompanying drawings.

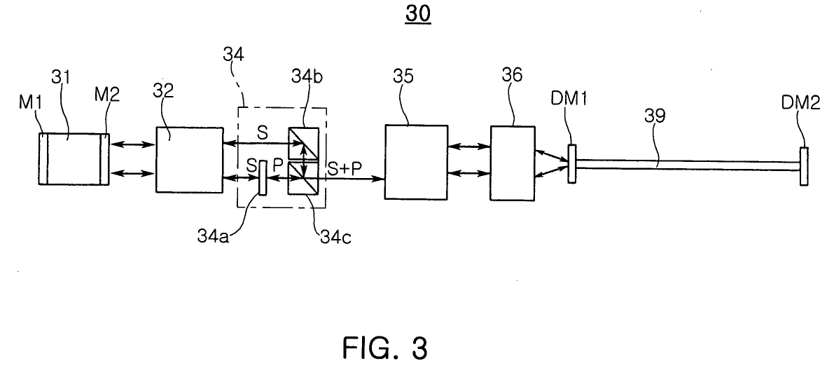

FIG. 3 is an up-conversion optical fiber laser apparatus with an external resonator structure according to one embodiment of the invention.

Referring to FIG. 3, the up-conversion optical fiber laser apparatus 30 includes an excitation laser device 31 for outputting an excitation laser beam and an optical fiber 39 having a core doped with rare earth ions. Also, a polarization mode controller 34 and a beam transformer 35 are disposed between the excitation laser device 31 and the optical fiber 39 to increase optical coupling efficiency. Further, a first light focusing means 32 is disposed between the laser device 31 and the polarization mode controller 34, and a second light focusing means 36 is disposed between the beam transformer 35 and the optical fiber 39. The focusing means 32 and 36 are exemplified by a collimator or a lens.

Hereinafter, in the specification, the excitation laser device 31 generates light of a wavelength of 835 nm, and the optical fiber 39 has a core doped with Pr ion and Yb ion to obtain an output light of a wavelength of 635 nm. However, the invention is not limited thereto. For example, the optical fiber 39 may have a core doped with other rare earth elements such as Tm, Ho or Er, and the laser device 31 may generate light of a wavelength different from the above example.

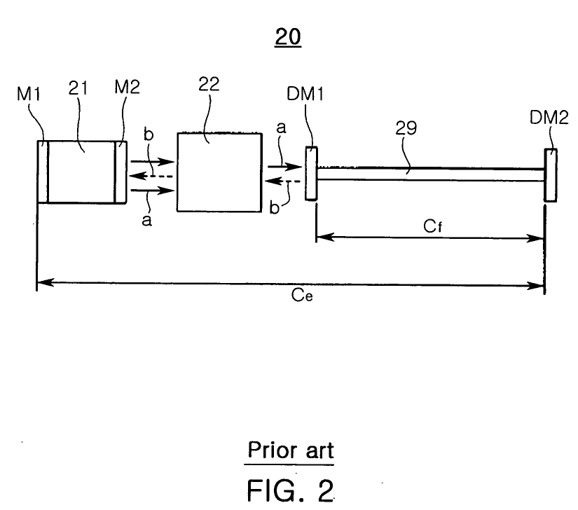

In the optical fiber laser apparatus 30, in a similar manner to FIG. 2, an input mirror DM1 and an output mirror DM2 cooperatively enable the optical fiber 39 to operate as a resonator for light of a wavelength of 635 nm. Also, a layer M2 having almost zero reflectivity (at 835 nm) is formed on a light exiting area of the laser device 31 so that a resonator structure of the laser device 31 is extended from a high reflective (HR) layer M1 facing the laser device 31 to the output mirror DM2 of the optical fiber 39. In this external resonator structure, a beam returning from the high reflective output mirror DM2 is used as an oscillation component.

To realize the aforesaid resonator structure, preferably the input mirror DM1 has anti-reflectivity for light of a wavelength of 835 nm and a high-reflectivity of 95% or more for light of a wavelength of 635 nm. Preferably, the output mirror DM2 has a high reflectivity of 95% or more for light of a wavelength of 835 nm and a low reflectivity of 10% to 30% for light of a wavelength of 635 nm.

In addition, the up-conversion laser apparatus 30 according to the invention employs a polarization mode controller 34 and a beam transformer 35 to boost optical coupling efficiency between the laser device 31 and the optical fiber 39.

The polarization mode controller 34 converts a polarization state of light returning from the optical fiber 39 into a state suitable for the laser device 31. The polarization mode controller 34 may include a phase retarder (PR) 34a for converting incident light into an orthogonal polarization wave, a first polarization beam divider 34b for reflecting only an eigen-polarization wave component for the laser device and a second polarization beam divider 34c for allowing passage of only a polarization wave component, orthogonal with respect to the eigen-polarization wave component. When the laser device 31 has an S polarized wave mode, the first polarization beam divider 34b selects only the S polarized wave mode to output to the laser device 31. Meanwhile, among light incident from the optical fiber 39, the second polarization beam divider 34c provides a P polarized wave to a phase retarder 34a and the S polarized wave mode to the first polarization beam divider 34b. Further, the phase retarder 34a converts the P polarized wave provided from the second polarization beam divider 34c into the S polarized wave to provide to the laser device 31. Consequently, regardless of polarization states of the light returning from the optical fiber 39, the polarization mode can be changed into the one as required by the laser device 31, thereby preventing degradation in optical coupling efficiency caused by birefringence of the optical fiber 39.

In addition, light traveling from the laser device 31 to the optical fiber adopts the aforesaid process of adjusting a polarization mode inversely. That is, through the polarization mode controller 34, as indicated with an arrow, light heading from the laser device 31 to the optical fiber 39 can be changed from light of the S polarized wave into light of both S and P polarized wave components.

In the polarization mode controller 34, the first polarization beam divider 34b functions equally even in case where it is substituted by a simple high reflective mirror oriented at 45° angle with respect to a light traveling direction. Hereinafter, in another embodiment of the invention, even without specific statements, it is apparent to those skilled in the art that the first polarization beam divider can be substituted by the mirror.

The polarization mode controller 34 may be structured to divide light incident from the laser device 31 such that a portion of the light enters the first polarization beam divider and another portion of the light enters the second polarization beam divider through the phase retarder 34a. Preferably, the polarization mode controller 34 divides light incident from the laser device 31 along a slow axis. Preferably, the polarization mode controller 34 divides light incident from the laser device 31 into substantially halves along the slow axis.

In addition, the beam transformer 35 converts a beam shape defined by beam quality M2 which increases in proportion to multiplication of a beam divergence angle and a beam size between the laser device 31 and the optical fiber 39. This additionally boosts optical coupling efficiency. That is, the beam transformer 35 converts light incident from the polarization mode controller 34 into a shape required by the optical fiber 39 and converts light incident from the optical fiber 39 into a shape required by the laser device 31.

In general, the beam shape outputted from the laser device 31 is much larger in a slow axis than in a fast axis. In contrast, in the optical fiber 39, the beam shape is sized almost identical in the fast axis and in the slow axis. Therefore, the beam transformer 35 divides a laser beam along the slow axis, rotates the divided beam at a predetermined angle, and rearranges the beam to convert into a beam shape suitable for the optical fiber 39. Also, the beam transformer 35 converts a shape of light returning from the optical fiber inversely. In this case, the beam transformer 35 can be configured into various optical structures such as lenses, mirrors and prisms. Typically, the laser beam is divided along the slow axis but basically the beam mode is divided based on an axis having a higher beam quality M² among two orthogonal axes.

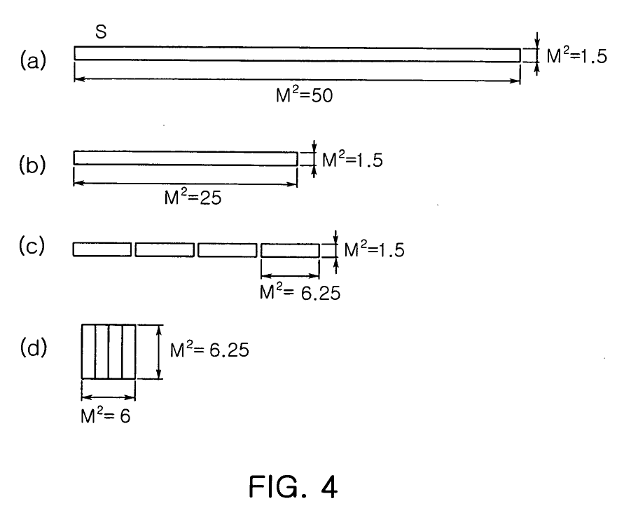

FIGS. 4(a) to 4(d) illustrate an example of method for converting a beam shape employed in the embodiment of the invention. Herein, as in FIG. 4(a), light outputted from the laser device 31 exhibits a beam quality M² of 50 for a slow axis and 1.5 for a fast axis. It is assumed that the optical fiber 39 is a multimode optical fiber, and requires a beam quality M² to be smaller than 6.

First, as shown in 4(b), before being inputted to the beam transformer 35, the polarization mode controller 34 divides a laser beam into halves along the slow axis in the aforesaid process of adjusting a polarization mode. Then, a portion of the divided light is converted into an orthogonally polarized light component by the phase retarder 34a and then synthesized with the other portion of divided light by the first and second polarization beam dividers 34b and 34c. This allows a beam having the fast axis maintained as the same and the slow axis defined by M²=25.

Then, as shown in FIG. 4(c), a beam is divided into quarters along the slow axis via a well-known means to provide a beam having the slow axis defined by M²=6.25. In this example, the beam is divided along the slow axis primarily by the polarization mode controller 34 but the invention is not limited thereto. But the polarization mode controller 34 capable of easy beam division executes a primary division, thereby advantageously simplifying configuration of the beam transformer 35 more.

Finally, as shown in FIG. 4(d), the beam divided along the slow axis is rotated at 90° and rearranged, thereby obtaining beam shape defined by M²⁼6 and 6.25 for each axis. The final beam can be coupled with the multi mode optical fiber defined by M²<6 with high efficiency via the second light focusing means 36.

In this manner, adjustment in polarization mode reduces losses and instability resulting from polarization changes. In addition, the beam shape can be converted reversibly into the mode befitting the laser device or optical fiber via a transform means, thereby dramatically increasing optical coupling efficiency between the laser device and optical fiber. Consequently, the up-conversion optical fiber laser apparatus 30 of such external resonator structure can have a high conversion efficiency in wavelength conversion from 835 nm to 635 nm.

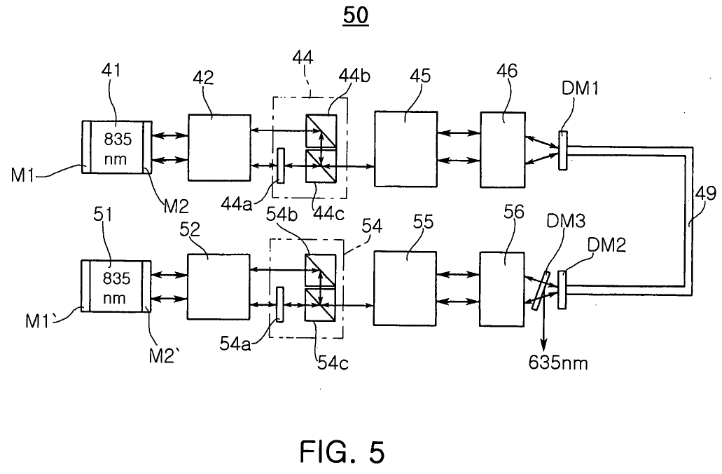

The up-conversion optical fiber laser apparatus with the external resonator structure according to the invention can be modified into various types using high optical coupling efficiency of the optical fiber and laser device. For example, two laser devices may be employed to enhance the overall intensity of an excitation light (see FIG. 5). Alternatively, to attain similar effects, the up-conversion optical fiber laser apparatus may be altered into a closed structure (ring structure) in which both ends of the optical fiber are optically connected to the beam transformer (see FIG. 7).

FIG. 5 illustrates an up-conversion optical fiber laser apparatus 50 with an external resonator structure according to another embodiment of the invention.

Referring to FIG. 5, the up-conversion optical fiber laser apparatus 50 includes first and second excitation laser devices 41 and 51 for outputting an excitation laser beam and an optical fiber 49 having a core doped with rare earth ions. First polarization mode controller 44 and a first beam transformer 45 are disposed between the first excitation laser device 41 and one end of the optical fiber 49. A second polarization mode controller 54 and a second beam transformer 55 are disposed between the second excitation laser device 51 and the other end of the optical fiber 49. Further, first light focusing means 42 and 52 are disposed between the first and second laser devices 41 and 51 and the first and second polarization mode controllers 44 and 54, respectively. Also, second light focusing means 46 and 56 are disposed between the first and second beam transformer 45 and 55 and the both ends of the optical fiber 49, respectively.

The first and second polarization mode controllers 44 and 54 each includes a phase retarder (PR) 44a, 54a for converting incident light into orthogonal polarized wave, a first polarization beam divider 44b, 54b for reflecting only an eigen-polarization wave component for the laser device and a second polarization beam divider 44c, 54c for allowing passage of only a polarization wave component orthogonal with respect to the eigen-polarization wave component. Thereby, a polarization state of light returning from both ends of the optical fiber 49 is converted into a state befitting the first and second laser devices 41 and 51. Also, the first and second beam transformers 45 and 55 convert a beam mode defined by a beam quality M² between the first and second laser devices 41 and 51 and the optical fiber 49, thereby additionally enhancing optical coupling efficiency.

In the up-conversion optical fiber laser device 50 according to the invention, an input mirror DM1 and an output mirror DM2 cooperatively enables the optical fiber 49 to operate as a resonator for a wavelength of 635 mm. Herein, light of a wavelength of 635 nm generated from the output mirror having low reflectivity therefore can be outputted to the outside via a final output mirror DM3.

In addition, light exiting surfaces M2 and M2′ of the first and second laser devices 41 and 51 and the input and output mirrors DM1 and DM2 have almost zero reflectivity for a wavelength of 835 nm so that the first and second laser devices 41 and 51 adopt as a resonator all structures between mirrors M1 and M1′ of the first and second laser devices having high reflectivity for a wavelength of 835 nm.

At this time, the final output mirror DM3 is disposed in front of the output mirror DM2. As described above, to output light of a wavelength of 635 nm to the outside, the final output mirror DM3 has a high reflectivity for light of a wavelength of 635 nm but anti-reflectivity for light of a wavelength of 835 nm to ensure the external resonator structure between the two laser mirrors M1 and M1′.

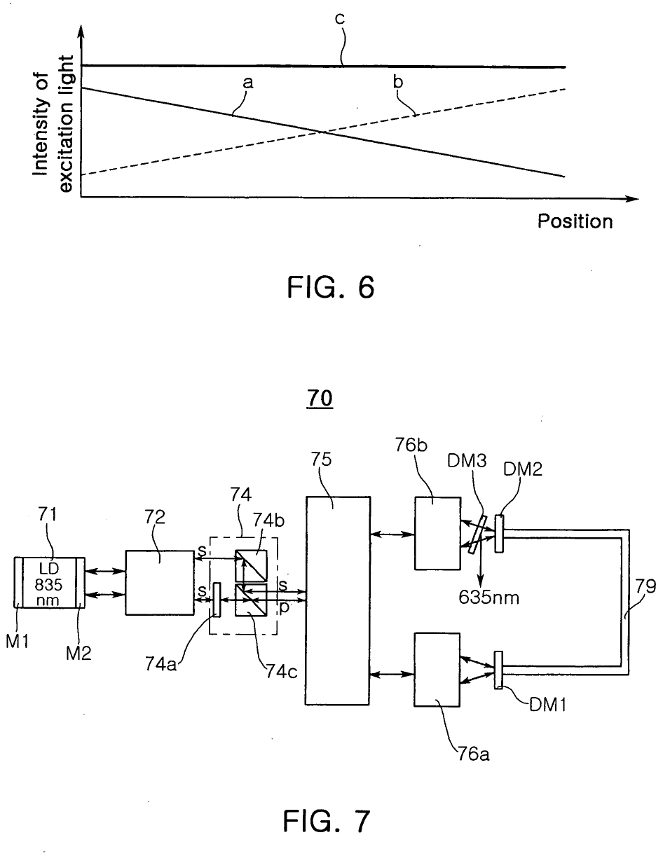

Therefore, the first and second polarization mode controllers 44 and 54 and the first and second beam transformers 45 and 55 guarantee high optical coupling efficiency between the first and second laser devices and both ends of the optical fiber 49. This allows the excitation light to be distributed at an ideal intensity profile in the external resonator structure for generating light of a wavelength of 835 nm as shown in FIG. 6.

That is, as shown in FIG. 6, light outputted from the first laser device 41 travels to the output mirror DM2 of the optical fiber 49 at a gradually declining intensity (see reference sign a). Meanwhile, light outputted from the second laser device 51 travels to the input mirror DM1 of the optical fiber at a gradually declining intensity (see reference sign b). Bold line (see reference sign c) indicates total excitation intensity, i.e., sum of the light outputted from the first laser device 41 and the light outputted from the second laser device 51. In this manner, a novel external resonator structure in which the excitation laser beam is provided to both ends of the optical fiber and propagates through the optical fiber can be realized via the polarization mode controller and beam transformer which ensure high light coupling efficiency.

As described above, according to the invention, the excitation light intensity can be doubled by using two laser devices. In addition, the excitation light can be distributed at a uniform intensity across a resonator area of the optical fiber. To achieve similar effects, as shown in FIG. 7, both ends of the optical fiber are optically connected to the beam transformer without employing the two laser devices.

FIG. 7 illustrates an up-conversion optical fiber laser apparatus with external resonator structure according to another embodiment of the invention.

The up-conversion optical fiber laser apparatus 70 shown in FIG. 7, in a similar manner to FIG. 3, includes an excitation laser device 71 for outputting an excitation laser beam and an optical fiber 79 having a core doped with rare earth ions. To boost optical coupling efficiency, a polarization mode controller 74 and a beam transformer 75 are disposed between the excitation laser device 71 and the optical fiber 79. Also, a first light focusing means 72 is disposed between the laser device 71 and the polarization mode controller 74. Second light focusing means 76 a and 76b are disposed between the beam transformer 75 and the optical fiber 79.

The polarization mode controller 74 includes a phase retarder 74a and first and second polarization beam dividers 74b and 74c, thereby converting a polarization state of light returning from both ends of the optical fiber 79 into a state suitable for the laser device 71. In addition, the beam transformer 75 converts a beam shape between the laser device 71 and the optical fiber 79 to additionally increase optical coupling efficiency.

Further, in the up-conversion optical fiber laser apparatus 70 according to the embodiment, the input mirror DM1 and output mirror DM2 cooperatively enable the optical fiber 79 to operate as a resonator for light of a wavelength of 635 nm.

However, unlike FIG. 3, in the embodiment, the second light focusing means includes two light focusing means 76a and 76b which are disposed in parallel to optically connect both ends of the optical fiber 79 to the beam transformer 75. Moreover, in a similar manner to FIG. 5, a light exiting area M2 of the laser device 71 and the input and output mirrors DM1 and DM2 have anti-reflectivity with almost zero reflectivity for a wavelength of 835 nm. This allows the laser device 71 a closed resonator structure which circulates through the optical fiber with the high reflective mirror M1 as a starting point. In a similar manner to FIG. 6, such a resonator structure ensures the excitation light to be distributed at a uniform intensity across the optical fiber 79.

In this embodiment of the invention, to output light of a wavelength of 635 nm and ensure external resonator structure for light of a wavelength of 835 nm, the final output mirror DM3 has high reflectivity for light of a wavelength of 635 nm and anti-reflectivity for light of a wavelength of 835 nm.

In the aforesaid up-conversion optical laser device, the mirror may be a dichroic mirror or an optical fiber grating mirror. But various types of mirrors satisfying reflectivity conditions may be employed. Also, the optical fiber adopted in the invention is not limited to a multimode optical fiber and is selected from a group consisting of a single mode optical fiber, a double-cladding optical fiber and a polarization maintaining optical fiber.

As set forth above, the invention provides an up-conversion optical fiber laser apparatus improved in optical coupling efficiency between a laser device and optical fiber by employing a polarization mode controller and a beam transformer. Also, the invention ensures an up-conversion optical fiber laser device with an external resonator structure to have high optical conversion efficiency by minimizing losses caused by mismatch of polarization mode and beam quality.

While the present invention has been shown and described in connection with the preferred embodiments, it will be apparent to those skilled in the art that modifications and variations can be made without departing from the spirit and scope of the invention as defined by the appended claims.

What is claimed is:

1. An up-conversion optical fiber laser apparatus comprising:
a laser element for outputting a first wavelength light, the laser element including a non-reflectivity layer formed on a light exiting area and a high reflective layer formed on an opposite area;
an up-conversion optical fiber having a core doped with a rare earth substance to convert the first wavelength light into a second wavelength light;
an output mirror disposed at an output end of the up-conversion optical fiber, the output mirror cooperating with the high reflective layer of the laser element to enable a predetermined portion of the laser apparatus from the laser element to the optical fiber to operate as a resonator for the first wavelength light;
an input mirror disposed at an input end of the up-conversion optical fiber, the input mirror cooperating with the output mirror to enable the optical fiber to operate as a resonator for the second wavelength light;
a polarization mode controller disposed between the laser element and the up-conversion optical fiber, for converting light incident from the optical fiber into light of eigen-polarization wave for the laser element and outputting the converted light to the laser element; and
a beam transformer disposed between the polarization mode controller and the up-conversion optical fiber, for converting light incident from the polarization mode controller into a shape required by the optical fiber and outputting the transformed light to the optical fiber, and inversely, light incident from the optical fiber into a shape required by the laser element and outputting the transformed light to the polarization mode controller.

2. The up-conversion optical fiber laser apparatus according to claim 1, wherein the polarization mode controller comprises:
a phase retarder for converting polarization state of incident light into an orthogonal polarization state;
a first polarization beam divider for reflecting only an eigen-polarization wave component for the laser element among the light returning to the laser element so that the reflected wave component directly exits to the laser element; and
a second polarization beam divider for allowing-passage of only a polarization wave component, orthogonal with respect to the eigen-polarization wave component so that the allowed wave component exits to the laser element as the eigen-polarization wave component through the phase retarder.

3. The up-conversion optical fiber laser apparatus according to claim 2, wherein the first polarization beam divider is structured such that reflected wave component of the incident light travels to the second polarization beam divider, and the second polarization beam divider is structured such that the reflected wave component of the incident light travels to the first polarization beam divider.

4. The up-conversion optical fiber laser apparatus according to claim 2, wherein the first polarization beam divider is substituted by a high reflective mirror disposed at 45 degree about a beam propagation direction.

5. The up-conversion optical fiber laser apparatus according to claim 2, wherein the polarization mode controller is structured to divide light incident from the laser element such that a portion of the light enters the first polarization beam divider and another portion of the light enters the second polarization beam divider.

6. The up-conversion optical fiber laser apparatus according to claim 5, wherein the polarization mode controller divides light incident from the laser element along a slow axis.

7. The up-conversion optical fiber laser apparatus according to claim 6, wherein the polarization mode controller divides light incident from the laser element into halves along the slow axis.

8. The up-conversion optical fiber laser apparatus according to claim 1, wherein the beam transformer divides light incident from the polarization mode controller, rotates the divided light at a predetermined angle, rearranges the light and outputs the transformed light to the optical fiber, and inversely, divides light incident from the optical fiber, rotates the divided light at a predetermined angle, rearrange the light approximately into a shape of the incident light from the polarization mode controller.

9. The up-conversion optical fiber laser apparatus according to claim 8, wherein the light is divided by the beam transformer along a slow axis.

10. The up-conversion optical fiber laser apparatus according to claim 1, wherein the input mirror disposed at the input end of the optical fiber has non-reflectivity for the first wavelength light, and high reflectivity of 95% or more for the second wavelength light.

11. The up-conversion optical fiber laser apparatus according to claim 1, wherein the output mirror disposed at the output end of the optical fiber has high reflectivity of 95% or more for the first wavelength light and low reflectivity of 10% to 30% for the second wavelength light.

12. An up-conversion optical fiber laser apparatus comprising:
first and second laser elements for outputting a first wavelength light, each of the first and second laser elements including a non-reflective layer formed on a light exiting area and a high reflective layer formed on an opposite area;
an up-conversion optical fiber having a core doped with a rare earth substance to convert the first wavelength light into a second wavelength light;
first and second mirrors disposed at both ends of the up-conversion optical fiber, the first and second mirrors having non-reflectivity for the first wavelength light so that high reflective layers of the first and second laser element operate as a resonator for the first wavelength light, and having high-reflectivity and low-reflectivity for the second wavelength light, respectively, so that the optical fiber operates as a resonator for the second wavelength light;
first and second polarization mode controllers disposed between the first and second laser element and both ends of the up-conversion optical fiber, respectively, wherein the first polarization mode controller is adapted to convert light incident from the optical fiber into light of eigen-polarization wave for the first laser element and outputs the converted light to the first laser element, and the second polarization mode controller is adapted to convert light incident from the optical fiber into light of eigen-polarization wave for the second laser element and outputs the converted light to the second laser element;
first and second beam transformers disposed between the first and second polarization mode controllers and the both ends of the up-conversion optical fiber, respectively, wherein the first beam transformer is adapted to convert light incident from the first polarization mode controller into a shape required by the optical fiber, and inversely, convert light incident from the optical fiber into a shape required by the first laser element, and the second beam transformer is adapted to convert light incident from the second polarization mode controller into a shape required by the optical fiber, and inversely, convert light incident from the optical fiber into a shape required by the second laser element;
a final output mirror having non-reflectivity for the first wavelength light and high-reflectivity for the second wavelength light, by which the second wavelength light outputted from the second mirror exits outside a resonator structure.

13. An up-conversion optical laser apparatus comprising:
a laser element for outputting a first wavelength light, the laser element including a non-reflective layer formed on a light exiting area and a high reflective layer formed on an opposite area;
an up-conversion optical fiber having a core doped with a rare earth substance to convert the first wavelength light into a second wavelength light;
first and second mirrors disposed at both ends of the up-conversion optical fiber, the first and second mirrors having non-reflectivity for the first wavelength light so that high reflective layer of the laser element operate as a resonator for the first wavelength light, and having high-reflectivity and low-reflectivity for the second wavelength light, respectively, so that the optical fiber operates as a resonator for the second wavelength light;
a polarization mode controller disposed between the laser element and the up-conversion optical fiber, for converting light incident from the optical fiber into light of eigen-polarization wave for the laser element and outputting the converted light to the laser element;
a beam transformer disposed between the polarization mode controller and the up-conversion optical fiber, for converting light incident from the polarization mode controller into a shape required by the optical fiber and outputting the transformed light to the optical fiber, and inversely, light incident from the optical fiber into a shape required by the laser element and outputting the transformed light to the polarization mode controller;
two light focusing means disposed in parallel such that the both ends of the up-conversion optical fiber are optically connected to the beam transformer; and
a final output mirror having non-reflectivity for the first wavelength light, and high reflectivity for the second wavelength light, by which the second wavelength light outputted from the second mirror exits outside a resonator structure.
